(19) United States
(12) Patent Application Publication
(10) Pub. No.: US 2003/0192041 A1
(43) Pub. Date: Oct. 9, 2003

(54) software distribution system and method

(76) Inventors: Duane E. Mentze, Roseville, CA (US); Robert D. Vaughan, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/116,387

(22) Filed: Apr. 3, 2002

(51) Int. Cl. G06F 9/445; G06F 17/30; G06F 7/00

(52) U.S. Cl. 717/177; 707/3; 707/10

(57) ABSTRACT

A system and method for facilitating automated distribution of software is disclosed. The components of a software distribution system cooperatively operated to provide assistance in selecting and locating software compatible with a target system and capable of performing desired functions. A target system automatically formulates a request for software. The software distribution system includes a software description database that supports searches directed at identifying software that is compatible with the request formulated by the target system. The software is stored in a software data repository communicatively coupled to the target system and is capable of forwarding the software to the target system.

### TECHNICAL FIELD

The present invention relates to software distribution.

### BACKGROUND ART

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data, ideas and trends in most areas of business, science, education and entertainment. Frequently, these advantageous results are realized through the use of software stored on a memory media and implemented by a processing device. Selecting and accessing appropriate software directed to producing desired results is often very cumbersome and complicated.

Software typically includes information utilized in the performance of a multitude of tasks directed towards providing a variety of results. For example, software is often used to control and direct device operations in a computer system. Software requirements for different systems typically vary and are seldom static. For example, most computer systems are not configured with identical components and the different components (e.g., printers, network cards, video cards, etc.) usually require different software device drivers. When a device is added to a system an appropriate device driver is required to be installed to enable the operating system to manage the device. New software is also often required to be added to a system to take advantage of advances in technology or provide functions included in new software programs.

Determining appropriate software for the performance of a task and successfully installing the software are activities requiring a relatively high degree of precision and accuracy. Choosing and loading an appropriate software application typically involves significant user interaction that often requires extensive specialized knowledge beyond the range of general user experience. For example, selected software usually has to coherently interact with very specific individual idiosyncrasies of numerous different devices. There are also numerous different functions a user may desire to implement and picking software capable of providing maximized results is usually very difficult. Selecting appropriate software and correctly installing it are usually critical to accomplishing desired results.

Providing users with a wide assortment of software and an opportunity for maximizing satisfaction with desired functionality is important. Centralized storage with access over a network for downloading of particularly desired software to distributed resources usually provides some advantages and relieves individual distributed systems from managing extraneous information. Traditional attempts at accessing software via a network system typically require the user to determine appropriate software, manage the software communication (e.g., via a file transfer protocol, hyper text transfer protocol, etc.) and install the software properly. Each of these activities are usually very susceptible to user error and users typically have difficulty with activities such as figuring out the system hardware with sufficient specificity, accurately conveying correct information in a communication protocol, and executing the proper instructions to install the software. Prior attempts at addressing software distribution usually involve the dissemination of information consisting of highly technical brief statements beyond the comprehension of the average user and offer little practical guidance.

Thus, the prior art requires a user to possess significant expertise and expend significant efforts in selecting appropriate software while being susceptible to erroneous user interaction.

### DISLOSURE OF THE INVENTION

A system and method for facilitating automated distribution of software is disclosed. The components of a software distribution system cooperatively operated to provide assistance in selecting and locating software compatible with a target system and capable of performing desired functions. A target system automatically formulates a request for software. The software distribution system includes a software description database that supports searches directed at identifying software that is compatible with the request formulated by the target system. The software is stored in a software data repository communicatively coupled to the target system and is capable of forwarding the software to the target system.

### BRIEF DESCRIPTION OF THE DRAWINGS

FIG. 1 is a block diagram showing a software distribution system for assisting selection and location of software in accordance with one embodiment of the present invention.

FIG. 2 is a flow chart illustrating a method for distributing software in accordance with an alternate embodiment of the present invention.

FIG. 3 is a flow chart illustrating a method for setting up software in accordance with an embodiment of the present invention.

FIG. 4 is a flow chart showing a software dissemination process for distributing software in accordance with another embodiment of the present invention.

FIG. 5 is a flow chart of an exemplary compatibility process utilized to search for software with characteristics corresponding to desired parameters in accordance with the present invention.

FIG. 6 is a block diagram illustrating a software distribution system in accordance with another embodiment of the present invention.

### BEST MODES FOR CARRYING OUT THE INVENTION

Reference will now be made in detail to the preferred embodiments of the invention, a software distribution system and method, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it is understood the present invention may be practiced without these specific details. In other instances, some items have not been described in detail as not to unnecessarily obscure aspects of the current invention.

A software distribution system and method in accordance with one embodiment facilitates convenient and efficient distribution of software. A user is provided assistance in selecting software that is compatible with a target device the user intends to utilize the software with. An analysis of the target device is executed and based upon the results a query indicating desired software parameters and attributes is developed. Provisions are also made for user desired objectives (e.g., special functionality) in the query. A search for software with characteristics corresponding to the attributes designated in the query is performed and potential matching software is identified. A selection process finalizes a software choice and the software files are communicated from a centralized repository to the target device and installed. In most instances, operations associated with selecting, accessing, and installing software are performed automatically thereby reducing arduous and error prone user interaction to a minimum. Thus, the user is relieved from performing convoluted tasks requiring a relatively high degree of knowledge and precision with regards to the target device or the software.

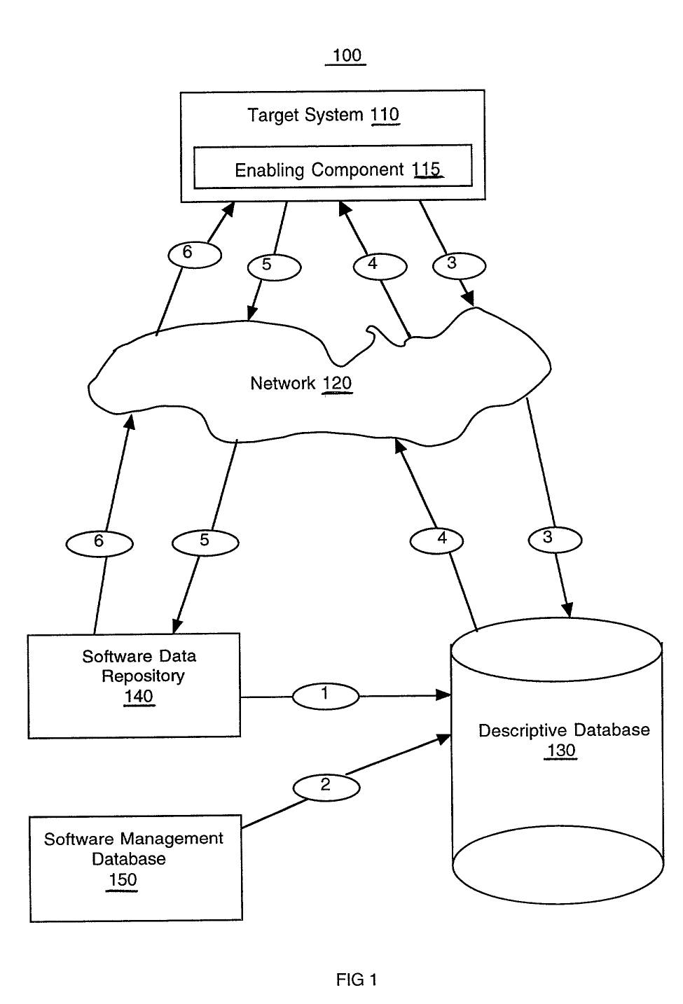

FIG. 1 is a block diagram illustrating components of software distribution system 100 in accordance with one embodiment of the present invention. Software distribution system 100 facilitates automation of software distribution by providing assistance for locating and loading software compatible with a target system and capable of performing desired functions. Software distribution system 100, comprises target system 110, network 120, software description database 130, software data repository 140 and optional software management database 150. Target device 110 is communicatively coupled via network 120 to software data repository 140 and software description component 130. Software description component 130 is also communicatively coupled to software data repository 140 and optional software management database 150.

The components of software distribution system 100 cooperatively operate to efficiently and conveniently distribute software. Software data repository 140 stores software and is capable of forwarding the software to target system 110. Distribution system 100 is readily adaptable for use with existing software repositories by treating the existing software repository as software data repository 140. Thus, extensive resources utilized to store existing software files are not necessarily required to be duplicated in a separate location or arrangement for use with the present invention. Software description database 130 stores information describing characteristics of the software in a manner that provides an association between the software and the information describing characteristics of the software. Target system 110 inspects the components included in target system 110 and automatically formulates a request for software intended for utilization and implementation on target system 110. The request is forwarded to software description database 130 which returns information designating matching software.

In one embodiment, descriptive information associated with the software in software data repository 140 is automatically extracted by software description database 130 in signal 1. Software distribution system 100 optionally includes a software management database 150 for managing software development. The software description database 130 also automatically extracts descriptive information in signal 2 from software management database 150.

Target system 110 comprises target enabling component 115 that performs software acquisition activities for target system 110. Target enabling component 115 includes software instructions stored on a computer readable medium of target system 110 and implemented by a processor included in target system 110. Target enabling component 115 automatically examines the components of target system 110 and determines software requirements. Thus, a user is not required to have extensive knowledge of the components included in a target system nor engage in convoluted activities directed at extracting the information from the system. The target enabling component 115 then develops a request for software matching the requirements (e.g., a request that specifies required software parameters). The request for the software is forwarded to descriptive database 130.

Software description database 130 supports searches that identify software in software data repository 140. Software description database 130 searches the characteristics included in the software description information looking for matches to software requirement parameters forwarded by target system 110 in signal 3. When a match is located, software description database 130 formulates a response that is forwarded to target system 110 in signal 4. The response includes software descriptive information including indications of software features and a location where the software is located.

Target system 110 automatically retrieves the software from software data repository 140. Target system 110 initiates a transfer protocol in signal 5 in which target system 110 provides the location of the desired software. Software data repository 140 transmits the identified software to target system 110 in signal 6. Target system 110 automatically installs the received software, and as part of the installation, target device 110 decompresses the software.

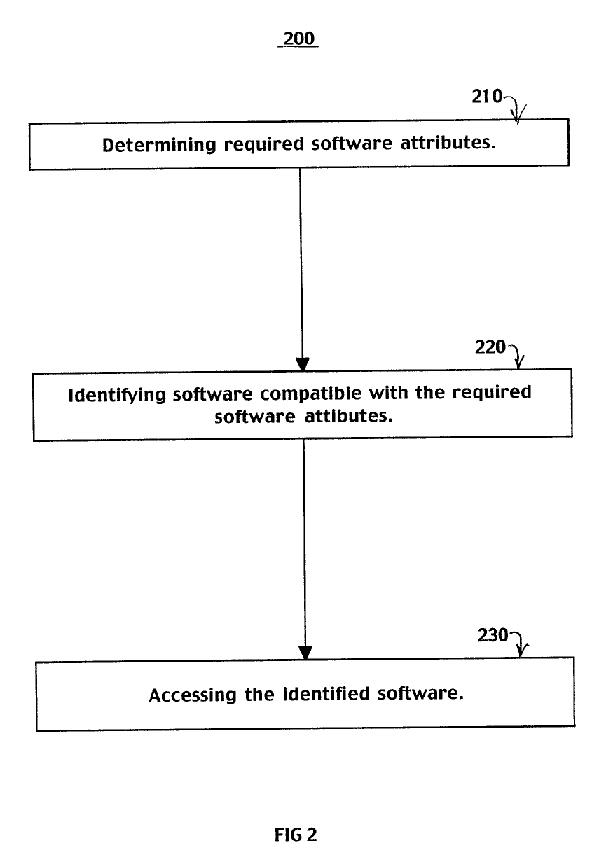

FIG. 2 is a flow chart illustrating method 200 for distributing software in accordance with an alternate embodiment of the present invention. Software distribution method 200 facilitates downloading software to distributed resources including selecting, finding, transferring and installing appropriate software for performing desired functionality. Thus, device driver software (e.g., a printer driver, video driver, etc.) that is compatible with a device and is capable of directing the device in realization of desired functionality can be automatically chosen and supplied. The software may be retrieved from a centralized server computer (e.g., a WEB server accessible via the Internet) and utilized on a remote personal computer.

In step 210, required software attributes are determined. A review of components included in a target device or system is performed. The target is a device or system attempting to access software that is capable of operably residing on the target device or system to provide desired functionality. Components of a target system or device requiring software are identified and parameters for the software are ascertained. In a target system or device with components (e.g., a printer, a video card, etc.) requiring software such as device driver files, the desired characteristics of the device drivers are identified. The software may be required to have attributes that make it compatible with a particular device, language (natural or computer) and operating system.

Software compatible with the required software attributes is identified in step 220. Software descriptive information in a database is searched for compatibility with the required software attributes and software with compatible software descriptive information is identified. The software descriptive information may include descriptions of software files stored in an existing data repository. The descriptive information is utilized to form software designation information associated with identified compatible software. Software designation information includes software feature information (e.g., indications of a device, language and operating system the software is compatible with).

In step 230, the software is accessed. The software is downloaded from a remote software repository via a network communication protocol, for example a file transfer protocol (FTP) or a hyper text transfer protocol (HTTP). Software designation information associated with identified compatible software is utilized to access the software. In addition to providing an indication of software features, the software designation information comprises information for uniquely identifying a software file on a network and is forwarded to target devices. For example, the software designation information includes a location or address of where the software is stored in a data repository.

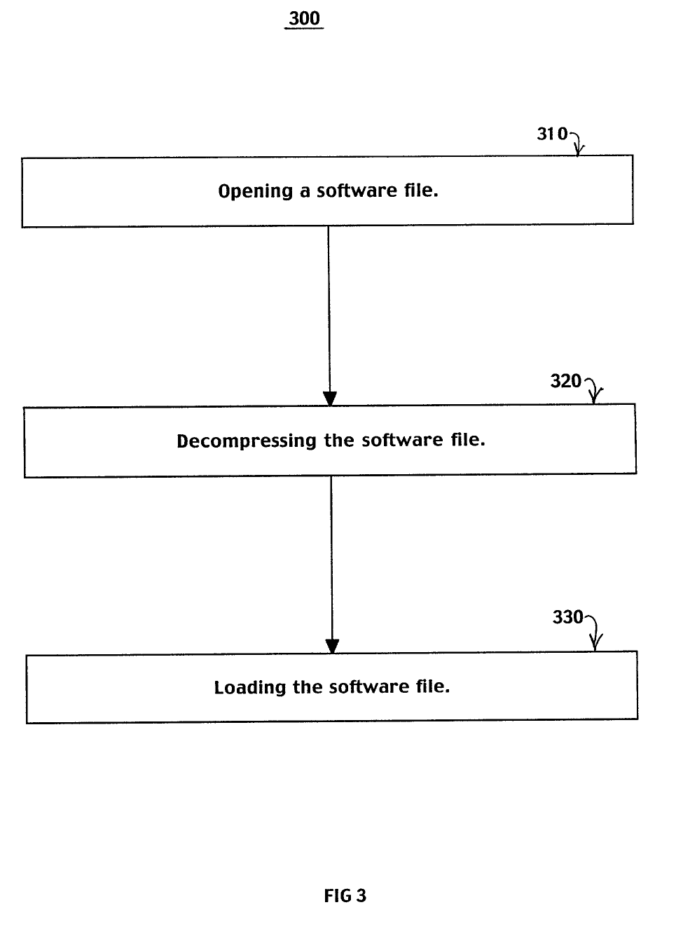

Accessed software may also be setup to begin operations. The software is configured to work with the target system and made ready to perform designated functions. A software configuration process is utilized to setup the software. FIG. 3 is a flow chart illustrating method 300 for setting up software in accordance with an embodiment of the present invention. In step 310, a software file downloaded in step 230 of software distribution method 200 is opened (e.g., by a target client personal computer). The software information is made available to the target system or device. The software file is decompressed in step 320. The data is restored to its original format by replacing indicators of bit patterns with the actual expanded bit patterns. At step 330, the software file is loaded and prepared to operate on the target device or system.

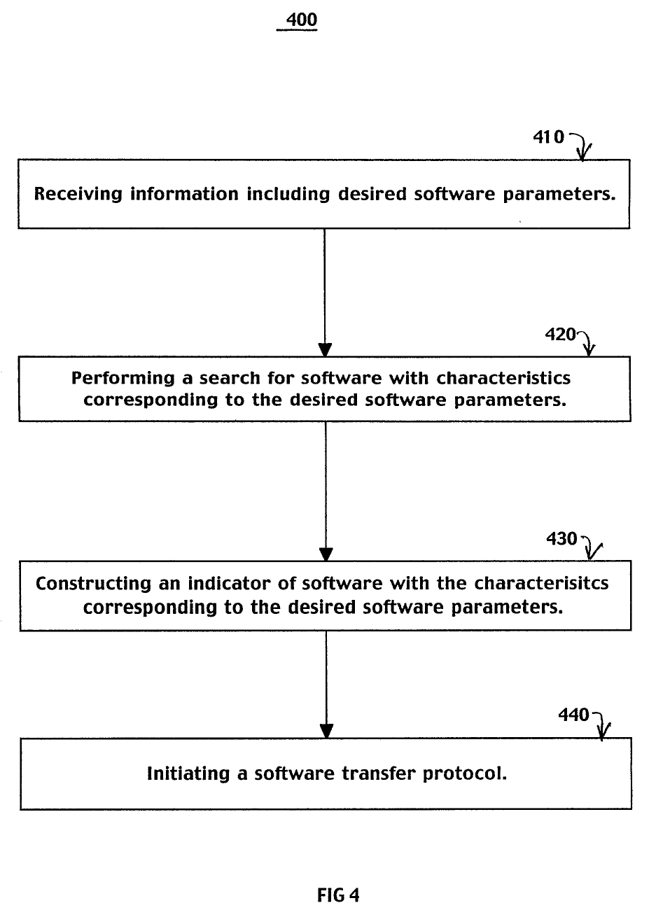

FIG. 4 is a flow chart of showing software dissemination process 400, another embodiment of a software distribution method in accordance with the present invention. Instructions for performing process 400 are stored in computer readable mediums and executed by processors. Software dissemination process 400 facilitates convenient distribution of software that is appropriately suited for utilization on a target device and performance of desired functions.

In step 410, information is received including desired software parameters. The information may be retrieved from a target device. If a target device does not provide sufficient information to adequately search for appropriate software, additional software parameter information is requested from the target device.

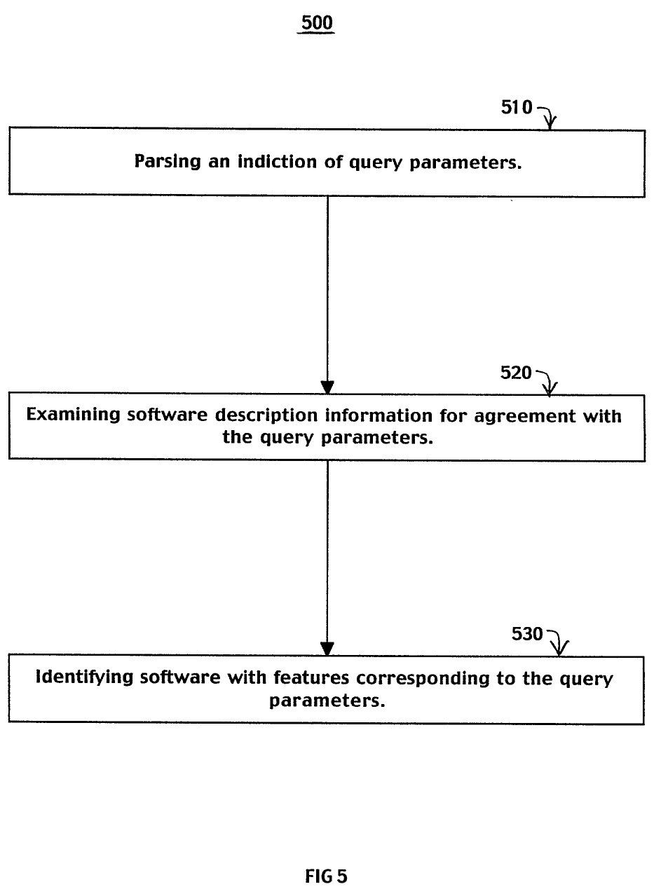

A search is performed in step 420 for software with characteristics corresponding to the desired software parameters. In one exemplary implementation a compatibility process is performed. FIG. 5 is a flow chart of showing compatibility process 500 which is utilized to search for software with characteristics corresponding to the desired software parameters. In step 510, an indication of query parameters is parsed. The query parameters are included in the indication of required software attributes. In step 520, a software description information is examined or agreements with the query parameters. For examples, the query parameters are compared to software feature indications included in the software description information. In step 530, software is identified. The features of the identified software correspond to the query parameters.

In step 430, an indicator of software with the appropriate characteristics found in step 420 is constructed and returned to the target device. For example, the indicator includes a file name and a location of the file. The indicator also includes indications of the software features (e.g., name of the software, operating system it is compatible with, devices it operates with, etc.).

In step 440, a software transfer protocol is initiated by the target device. The software transfer protocol comprises downloading the software over a network via a communication transfer protocol (e.g., ftp or http). The software transfer protocol also includes opening the software file after transfer.

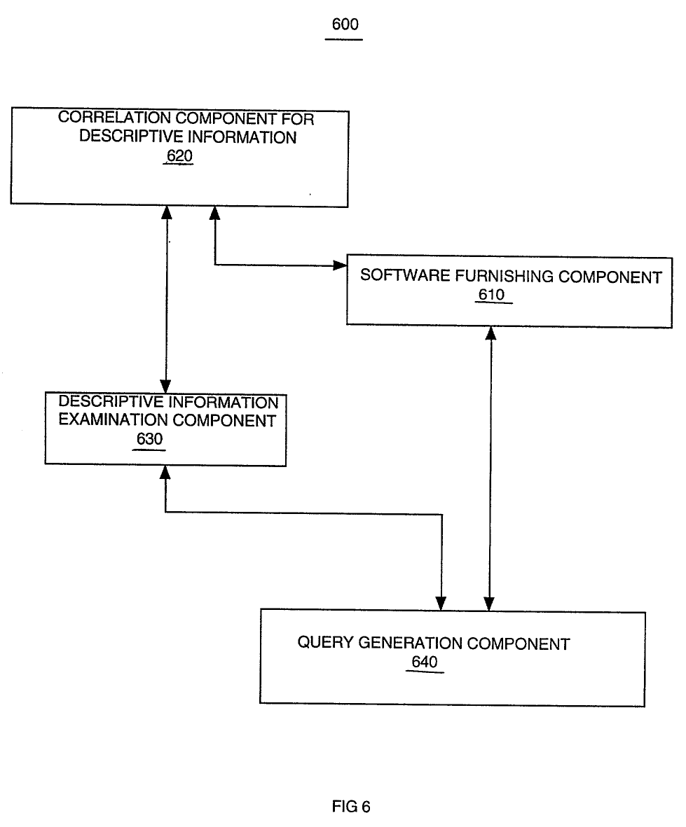

FIG. 6 is a block diagram showing software distribution system 600, in accordance with another implementation of a present invention software distribution system. Software distribution system 600 comprises software furnishing component 610, descriptive information examination component 630, correlation component 620, and query generation component 640. Software furnishing component 610 is communicatively coupled to correlation component 620 which is communicatively coupled to descriptive information examination component 630. Descriptive information examination component 630 is also communicatively coupled to query generation component 640.

The components of software distribution system 600 cooperatively operate in software distribution activities. Furnishing component 610 furnishes software. Correlation component 620 provides a correlation between software and information describing the software. In one embodiment, correlation component 620 tracks a correspondence between performance characteristics and the software. Query generation component 640 generates a query for software with indicated characteristics derived by interrogating a target system for information on desired software characteristics. Fort example, query generation component 640 interrogates a destination device for information associated with desired software characteristics (e.g., information indicating an operating system utilized by a device). Descriptive information examination component 630 examines the descriptive information included in correlation component 620 seeking agreements between the software descriptive information and query indicated characteristics. The descriptive information examination component 630 searches software descriptive information included in correlation component 620 and utilizes the provided correlation to identify software corresponding to query indicated characteristics.

Software distribution system 600 may also include an installation component (not shown) in some implementations. The installation component is communicatively coupled to and receives software information from software furnishing component 610. The installation component performs a software configuration process such as software configuration process 300 shown in FIG. 3. The software is downloaded, decompressed, and prepared to operate on a system or device that includes the query generation component.

Thus, a present system and method for distributing software facilitates convenient access to software having appropriate characteristics for implementation on a target system. The software distribution system and method is readily adaptable for use with existing software repositories without the need for maintaining essentially duplicate copies of the software files. A user is relieved from delving into complicated operations associated with identifying and accessing appropriate software for a system (e.g., device drivers for devices included in a system). The software distribution system and method automatically selects, retrieves and installs software. Thereby, reducing potential problems associated with user selection and or input errors. Alternatively, meaningful user participation is assisted by prompting a user with simplified choices in an easy to understand format with optional helpful hints on potential advantages or disadvantages of a particular choice.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application with the intent of enabling others skilled in the art to utilize the invention and different embodiments, with various modifications as are suited to the particular use contemplated. It is intended that the scope of the invention be defined by the Claims appended hereto and their equivalents.

What is claimed is:

1. A software distribution system comprising:
a software description database that supports searches that identify software that is compatible with a request for said software;
a target system coupled to said software description database, said target system automatically formulates said request for said software; and
a software data repository coupled to said target system, said software data repository stores said software and is capable of forwarding said software to said target system.

2. The software distribution system of claim 1 wherein said software description database stores information describing characteristics of said software in a manner that provides an association between said software and said information describing characteristics of said software.

3. The software distribution system of claim 1 wherein said target system comprises a target enabling component that performs software acquisition activities for said target system including automatically examining components of said target system and determining software requirements.

4. The software distribution system of claim 3 wherein said target enabling component develops said request for software based upon said software requirements.

5. The software distribution system of claim 1 wherein said software description database searches characteristics included in software description information looking for matches to software requirement parameters forwarded by said target system.

6. The software distribution system of claim 1 wherein said software description database automatically extracts descriptive information associated with said software from said software data repository.

7. The software distribution system of claim 1 further comprising a software management database coupled to said software description database, said software management database manages software development and said software description database automatically extracts descriptive information from said software management database.

8. The software distribution system of claim 7 wherein said software description database formulates a response that is forwarded to said target system, said response includes software descriptive information including indications of software features and a location where said software is located.

9. The software distribution system of claim 1 wherein said target system automatically retrieves said software from said software data repository by initiating a file transfer protocol in which said target system provides a location of said software and said software data repository transmits the identified software to said target system.

10. The software distribution system of claim 9 wherein said target system automatically decompresses and installs said software.

11. A software distribution method comprising:
determining required software attributes automatically;
identifying software compatible with said required software attributes; and
accessing said software.

12. A software distribution method of claim 11 wherein said required software attributes include an indication of a device, a language, and an operating system.

13. A software distribution method of claim 12 wherein said language utilized with said device is a natural language.

14. A software distribution method of claim 11 wherein said software includes a device driver file.

15. A software distribution method of claim 11 wherein said software is identified by designation information including a location where said software is stored and software feature information.

16. A software distribution method of claim 11 further comprising downloading said software.

17. A software distribution method of claim 11 further comprising setting up said software to begin operations.

18. A computer readable medium comprising instructions which when executed by a computer system causes said computer system to implement a process comprising:
receiving information including software parameters;
searching for software with characteristics corresponding to said software parameters; and
constructing an indicator to said software with said characteristics.

19. The process of claim 18 further comprises requesting said information from a target device.

20. The process of claim 18 wherein searching for software with characteristics corresponding to said parameters includes performing a compatibility process.

21. The process of claim 22 wherein said compatibility process comprises:
parsing an indication of query parameters;
examining software description information for agreement with said query parameters; and
identifying software with features corresponding to said query parameters.

22. A software distribution system comprising:
a means for furnishing software;
a means for correlating said software to descriptive information;
a means for generating a query for said software with indicated characteristics derived by interrogating a target system for information on desired software characteristics; and
a means for examining said descriptive information.

23. A software distribution system of claim 22 wherein said means for examining said descriptive information facilitates resolution of a query to identify said software compatible with said indicated characteristics included in said query.

24. A software distribution system of claim 22 wherein said means for examining said descriptive information utilizes a correlation provided by said means for correlating said software and said descriptive information to provide an indication of said software corresponding to said query indicated characteristics.

25. A software distribution system of claim 22 wherein said means for correlating said software to descriptive information tracks a correspondence between performance characteristics and said software.

26. A software distribution system of claim 22 further comprising a means for installing said software.

27. A software distribution system of claim 26 wherein said software is downloaded, decompressed, and prepared to operate on a system that includes said means for generating a query.
